(19) United States
(12) Patent Application Publication
(10) Pub. No.: US 2023/0396743 A1
(43) Pub. Date: Dec. 7, 2023

(54) ADAPTER FOR OPTICAL TRANSMISSION SYSTEM

(71) Applicant: Nihon Video System Co., Ltd., Tsushima-shi (JP)

(72) Inventors: Akikazu Hashiguchi, Tsushima-shi (JP); Kentaro Hashiguchi, Tsushima-shi (JP)

(73) Assignee: Nihon Video System Co., Ltd., Tsushima-shi (JP)

(21) Appl. No.: 18/451,713

(22) Filed: Aug. 17, 2023

(30) Foreign Application Priority Data
Feb. 8, 2021 (JP) 2021-018528

(51) Int. Cl. H04N 7/22; H04N 5/268; H04J 14/02; H04B 10/25

(52) U.S. Cl. CPC H04N 7/22; H04N 5/268; H04J 14/02; H04B 10/25

(57) ABSTRACT

The present invention is directed to improve the convenience and comfort of the shooting site. According to the present invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, at least one of an internal reflectance of the optical cable and light intensity in multiple frequency bands can be displayed on the display part.

### TECHNICAL FIELD

The present invention relates to an adaptor for an optical transmission system configured to optically transmit an analog video signal or a digital video signal between a pair of adaptors.

A video signal of an image captured by a video camera is sent to a video switcher or the like via a transmission cable. When these devices are remotely installed, it is difficult to transmit an electric signal without attenuation. For this reason, long-distance transmission is performed by converting the electric signal into an optical signal on a video camera side, transmitting this optical signal through an optical transmission cable, and then converting the optical signal into the electric signal on a remote device side (Patent Literature 1).

### CITATION LIST

### Patent Literature

Patent Literature 1: JP-A-2006-191161

### SUMMARY OF INVENTION

### Technical Problem

Since 4K broadcasting and 8K broadcasting started on BS, etc., the demand for high-definition video has increased significantly. Four 12G-SDI or 3G-SDI are often used for shooting. Four 12G-SDIs are mainly used for 8K broadcasting. However, in 12G-SDI, the transmission distance of BNC cables is very short, and long-distance transmission using optical cables is desired.

Adapters for transmission using optical cables are used today as equipment for broadcasting operations. However, in addition to video signals such as 12G-SDI, adapters using optical cables are used to transmit many signals such as audio signals, time codes, and intercoms, and there is a demand for multifunctionality.

In addition, liquid crystal display units are used today that allow the contents of the optical transmission equipment to be seen at a glance, but there is also a growing demand for knowing the details of the optical transmission environment. These improvements are urgently needed.

Based on the above circumstances, the present invention was filed in order to improve the convenience and comfort of the shooting site.

### Solution to Problem

According to the present invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, at least one of an internal reflectance of the optical cable and light intensity in multiple frequency bands can be displayed on the display part.

Preferably, the adapter described above is an adapter for an optical transmission system, wherein the light intensity capable of indicating the internal reflectance of the optical cable can be displayed on the display part.

Preferably, the adapter described above is an adapter for an optical transmission system, wherein light intensity in multiple frequency bands can be displayed on the display part.

Preferably, the adapter described above is an adapter for an optical transmission system, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, two types or multiple hour meters can be displayed on the display part.

Preferably, the adapter described above is an adapter for an optical transmission system, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, a device that requires synchronization of the PTP clock can be connected, and the other side of the optical transmission device to which the synchronization signal is transmitted has a circuit compatible with the PTP clock.

Preferably, the adapter described above is an adapter for an optical transmission system, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, it is possible to connect a TW specification intercom capable of sending two intercom lines to the 1st adapter for the optical transmission system, and directly connect a RW specification intercom to the second optical transmission system adapter.

Preferably, the adapter described above is an adapter for an optical transmission system, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, a video signal for a prompter is transmitted, the 1st adapter for the optical transmission system has a prompter-dedicated remote control terminal to which a prompter remote control can be connected, a prompter externally connected to the second camera adapter can be controlled via the 1st adapter for the optical transmission system.

Preferably, the adapter described above is an adapter for an optical transmission system, wherein from the 1st adapter for optical transmission system to the 2nd adapter for optical transmission system or vice versa, by pressing the call button from one adapter side, the LED lamp on the other side lights up or flashes for display, or a buzzer sounds, so that the other party can be notified with either or both of the buzzer and LED lamp.

Preferably, the adapter described above is an adapter for an optical transmission system, wherein when the power is connected to the 1st optical adapter and the second optical adapter is connected with a cable, the intercom line intercept the power from the 1st optical adapter before the power switch of the second optical adapter even without turning on the power switch of the second optical adapter, and the intercom line has a circuit that keeps the power of the intercom line always on when the 1st optical adapter is connected, so that communication is always possible and a call can be made.

Preferably, the adapter described above is an adapter for an optical transmission system, wherein when the tally signal connected to the optical adapter is input, the fan inside the optical adapter is stopped.

Preferably, the adapter described above is an adapter for an optical transmission system, wherein when the tally signal connected to the optical adapter is input, the fan inside the optical adapter is stopped, and the stop time of the FAN can be changed.

Preferably, the adapter described above is an adapter for an optical transmission system, wherein two or more units of the 1st optical adapter can be connected by daisy chaining the tally signal connected to the video switcher to another 1st optical adapter.

Preferably, the adapter described above is an adapter for an optical transmission system, wherein two or more units of the 1st optical adapter can be connected by daisy chaining the tally signal connected to the video switcher to another 1st optical adapter, and the 1st optical adapter has a function to set a camera number arbitrarily and to light up when the 1st optical adapter receives a tally signal with the camera number from the switcher.

Preferably, the adapter described above is an adapter for an optical transmission system, wherein the adapter includes a built-in color bar generator to output a color bar signal.

Preferably, the adapter described above is an adapter for an optical transmission system, wherein the adapter includes a built-in color barge generator for arbitrary data volume such as 3 Gbps or 12 Gbps to output a color bar signal.

Preferably, the adapter described above is an adapter for an optical transmission system, wherein the adapter includes a built-in 1 kHz audio signal generation circuit that generates audio reference signal to equipment connected to an optical adapter, and output the audio reference signal

Preferably, the adapter described above is an adapter for an optical transmission system, wherein the adapter includes a built-in circuit which can generate a color bar signal and a 1 kHz audio reference signal at the same time and output the color bar signal and the 1 kHz audio reference signal.

Preferably, the adapter described above is an adapter for an optical transmission system, wherein a time code signal can be connected to the 1st optical adapter and the 1st optical adapter has a through-out output terminal for the time code signal.

Preferably, the adapter described above is an adapter for an optical transmission system, wherein either or both of the 1st optical adapter and the second optical adapter have a built-in time code generator and output a time code signal.

Preferably, the adapter described above is an adapter for an optical transmission system, wherein either or both of the 1st optical adapter and the second optical adapter have a built-in black burst signal generator and output a black burst signal.

Preferably, the adapter described above is an adapter for an optical transmission system, wherein a plurality of 1st optical adapters are connected by link cables, information communication between the 1st optical adapters is possible, and the contents of other 1st optical adapters can be read and displayed.

Preferably, the adapter described above is an adapter for an optical transmission system, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, since a broadcast SMPTE cable contains two optical cables, the signal from the optical multiplexer/demultiplexer can be divided into two and the same optical signal can be sent to the two optical cables of one SMPTE cable at the same time.

Preferably, the adapter described above is an adapter for an optical transmission system, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, since a broadcasting SMPTE cables contain two optical cables, the signal from the optical multiplexer/demultiplexer is optically transmitted through one of the optical cables, and when the signal is interrupted, the optical switch switches one of the optical cable to the other of the optical cable, and the signal from the optical multiplexer/demultiplexer can be sent via the other of the optical cable.

Preferably, the adapter described above is an adapter for an optical transmission system, wherein an input power source can be displayed on the display part. of the adapter, and the adapter has a function that can display what power source is being driven on the connected optical transmission system adapter on the other side.

Preferably, the adapter described above is an adapter for an optical transmission system, wherein the adapter has a function that can output via the through-out terminal an image obtained by down-converting the data amount of the input digital video signal.

Preferably, the adapter described above is an adapter for an optical transmission system, wherein when a signal to switch the return signal to the monitor is sent to either the 1st optical adapter or the second optical adapter, or both, from a remote controller, etc., the return signal input to the other adapter can be selected.

Preferably, the adapter described above is an adapter for an optical transmission system, wherein the adapter has a function to visualize the volume level of the intercom with an indicator.

Preferably, the adapter described above is an adapter for an optical transmission system, wherein when the Clear-com(intercom) master and slave devices are connected to each other's optical transmission system adapters, power is supplied to the slave device only when the Clear-com(intercom) master device is powered on.

### BRIEF DESCRIPTION OF DRAWINGS

FIG. 1 is a block diagram showing an optical transmission system according to one embodiment of the present invention.

FIG. 2 is another diagram A showing a detailed optical transmission system of one embodiment of the present invention;

FIG. 3 is another diagram B showing a detailed optical transmission system of one embodiment of the present invention;

FIG. 4 is another diagram C showing a detailed optical transmission system of one embodiment of the present invention;

### DESCRIPTION OF EMBODIMENTS

The present invention also provides the following inventions. The inventions below can be combined as appropriate.

According to the 1st invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, two or more light intensities can be displayed on the display part.

According to the second invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, an internal reflectance of the optical cable can be displayed on the display part.

According to the third invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, an light intensity and an internal reflectance of the optical cable can be displayed on the display part. at the same time.

According to the fourth invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, two types or multiple hour meters can be displayed on the display part.

According to the fifth invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, a device that requires synchronization of the PTP clock can be connected, and the other side of the optical transmission device to which the synchronization signal is transmitted has a circuit compatible with the PTP clock.

According to the sixth invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, it is possible to connect a TW specification intercom capable of sending two intercom lines to the 1st adapter for the optical transmission system, and directly connect a RW specification intercom to the second optical transmission system adapter.

According to the seventh invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, a video signal for a prompter is transmitted, the 1st adapter for the optical transmission system has a prompter-dedicated remote control terminal to which a prompter remote control can be connected, a prompter externally connected to the second camera adapter can be controlled via the 1st adapter for the optical transmission system.

According to the eighth invention, an adapter for an optical transmission system for optically transmitting analog video signals, digital video signals, control signals, audio signals, or a combination thereof between a pair of the adapters, wherein from the 1st adapter for optical transmission system to the 2nd adapter for optical transmission system or vice versa, by pressing the call button from one adapter side, the LED lamp on the other side lights up or flashes for display, or a buzzer sounds, so that the other party can be notified with either or both of the buzzer and LED lamp.

According to the ninth invention, an adapter for an optical transmission system for optically transmitting analog video signals, digital video signals, control signals, audio signals, or a combination thereof between a pair of the adapters, wherein when the power is connected to the 1st optical adapter and the second optical adapter is connected with a cable, the intercom line intercept the power from the 1st optical adapter before the power switch of the second optical adapter even without turning on the power switch of the second optical adapter, and the intercom line has a circuit that keeps the power of the intercom line always on when the 1st optical adapter is connected, so that communication is always possible and a call can be made.

According to the tenth invention, an adapter for an optical transmission system for optically transmitting analog video signals, digital video signals, control signals, audio signals, or a combination thereof between a pair of the adapters, wherein when the tally signal connected to the optical adapter is input, the fan inside the optical adapter is stopped.

According to the eleventh invention, an adapter for an optical transmission system for optically transmitting analog video signals, digital video signals, control signals, audio signals, or a combination thereof between a pair of the adapters, wherein when the tally signal connected to the optical adapter is input, the fan inside the optical adapter is stopped, and the stop time of the FAN can be changed.

According to the twelfth invention, an adapter for an optical transmission system for optically transmitting analog video signals, digital video signals, control signals, audio signals, or a combination thereof between a pair of the adapters, wherein two or more units of the 1st optical adapter can be connected by daisy chaining the tally signal connected to the video switcher to another 1st optical adapter.

According to the thirteenth invention, an adapter for an optical transmission system for optically transmitting analog video signals, digital video signals, control signals, audio signals, or a combination thereof between a pair of the adapters, wherein two or more units of the 1st optical adapter can be connected by daisy chaining the tally signal connected to the video switcher to another 1st optical adapter, and the 1st optical adapter has a function to set a camera number arbitrarily and to light up when the 1st optical adapter receives a tally signal with the camera number from the switcher.

According to the fourteenth invention, an adapter for an optical transmission system for optically transmitting analog video signals, digital video signals, control signals, audio signals, or a combination thereof between a pair of the adapters, wherein the adapter includes a built-in color bar generator to output a color bar signal.

According to the fifteenth invention, an adapter for an optical transmission system for optically transmitting analog video signals, digital video signals, control signals, audio signals, or a combination thereof between a pair of the adapters, wherein the adapter includes a built-in color barge generator for arbitrary data volume such as 3 Gbps or 12 Gbps to output a color bar signal.

According to the sixteenth invention, an adapter for an optical transmission system for optically transmitting analog video signals, digital video signals, control signals, audio signals, or a combination thereof between a pair of the adapters, wherein the adapter includes a built-in 1 kHz audio signal generation circuit that generates audio reference signal to equipment connected to an optical adapter, and output the audio reference signal.

According to the seventeenth invention, an adapter for an optical transmission system for optically transmitting analog video signals, digital video signals, control signals, audio signals, or a combination thereof between a pair of the adapters, wherein the adapter includes a built-in circuit which can generate a color bar signal and a 1 kHz audio reference signal at the same time and output the color bar signal and the 1 kHz audio reference signal.

According to the eighteenth invention, an adapter for an optical transmission system for optically transmitting analog video signals, digital video signals, control signals, audio signals, or a combination thereof between a pair of the adapters, wherein a time code signal can be connected to the 1st optical adapter and the 1st optical adapter has a through-out output terminal for the time code signal.

According to the nineteenth invention, an adapter for an optical transmission system for optically transmitting analog video signals, digital video signals, control signals, audio signals, or a combination thereof between a pair of the adapters, wherein either or both of the 1st optical adapter and the second optical adapter have a built-in time code generator and output a time code signal.

According to the twentieth invention, an adapter for an optical transmission system for optically transmitting analog video signals, digital video signals, control signals, audio signals, or a combination thereof between a pair of the adapters, wherein either or both of the 1st optical adapter and the second optical adapter have a built-in black burst signal generator and output a black burst signal.

According to the twenty-1st invention, an adapter for an optical transmission system for optically transmitting analog video signals, digital video signals, control signals, audio signals, or a combination thereof between a pair of the adapters, wherein a plurality of 1st optical adapters are connected by link cables, information communication between the 1st optical adapters is possible, and the contents of other 1st optical adapters can be read and displayed.

According to the twenty-second invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, since a broadcast SMPTE cable contains two optical cables, the signal from the optical multiplexer/demultiplexer can be divided into two and the same optical signal can be sent to the two optical cables of one SMPTE cable at the same time.

According to the twenty-third invention, an adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, since a broadcasting SMPTE cables contain two optical cables, the signal from the optical multiplexer/demultiplexer is optically transmitted through one of the optical cables, and when the signal is interrupted, the optical switch switches one of the optical cable to the other of the optical cable, and the signal from the optical multiplexer/demultiplexer can be sent via the other of the optical cable.

According to the twenty-fourth invention, an adapter for an optical transmission system for optically transmitting analog video signals, digital video signals, control signals, audio signals, or a combination thereof between a pair of the adapters, wherein an input power source can be displayed on the display part. of the adapter, and the adapter has a function that can display what power source is being driven on the connected optical transmission system adapter on the other side.

According to the twenty-fifth invention, an adapter for an optical transmission system for optically transmitting analog video signals, digital video signals, control signals, audio signals, or a combination thereof between a pair of the adapters, wherein the adapter has a function that can output via the through-out terminal an image obtained by down-converting the data amount of the input digital video signal.

According to the twenty-sixth invention, an adapter for an optical transmission system for optically transmitting analog video signals, digital video signals, control signals, audio signals, or a combination thereof between a pair of the adapters, wherein when a signal to switch the return signal to the monitor is sent to either the 1st optical adapter or the second optical adapter, or both, from a remote controller, etc., the return signal input to the other adapter can be selected.

According to the twenty-seventh invention, an adapter for an optical transmission system for optically transmitting analog video signals, digital video signals, control signals, audio signals, or a combination thereof between a pair of the adapters, wherein the adapter has a function to visualize the volume level of the intercom with an indicator.

According to the twenty-eighth invention, an adapter for an optical transmission system for optically transmitting analog video signals, digital video signals, control signals, audio signals, or a combination thereof between a pair of the adapters, wherein when the Clear-com(intercom) master and slave devices are connected to each other's optical transmission system adapters, power is supplied to the slave device only when the Clear-com(intercom) master device is powered on.

Embodiments of the present invention will be described below with reference to the drawings. Various features shown in the embodiments shown below can be combined with each other. In addition, the invention is established independently for each characteristic item.

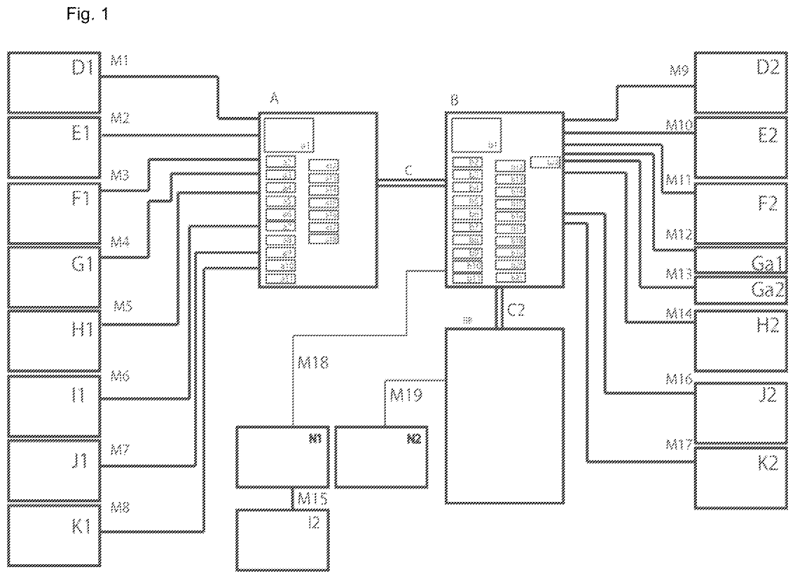

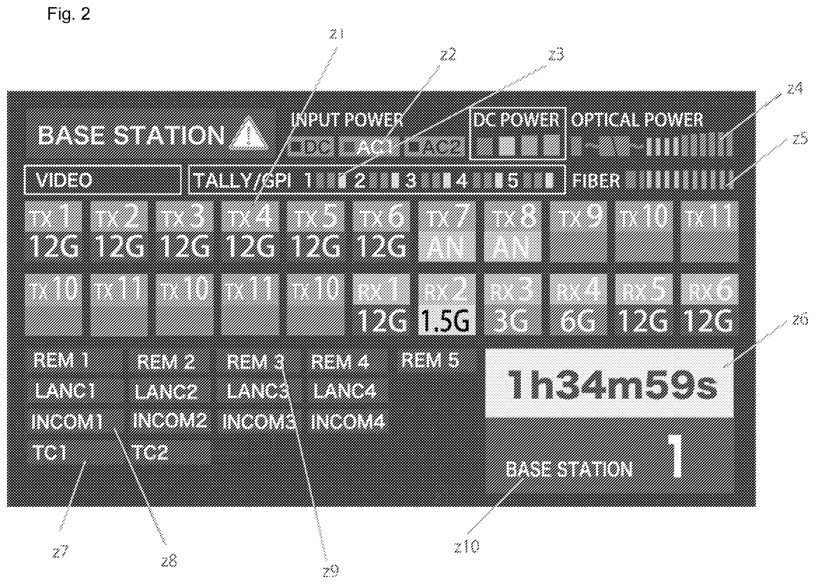

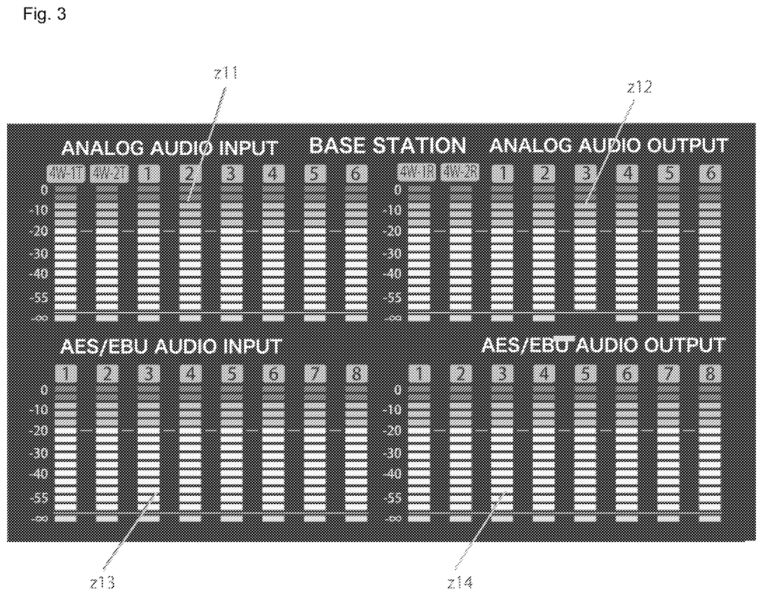

An optical transmission system according to an embodiment of the present invention will be described below with reference to FIGS. 1 to 4. The optical transmission system of this embodiment uses an optical multiplexer/demultiplexer used for DWDM or CWDM when communicating between the 1st adapter A and the 2nd adapter B, and the light intensity is the strongest at that time. The frequency band and the frequency band with the lowest light intensity are discriminated and displayed on the liquid crystal display portions a1 and b1, respectively. Description of the 1st invention

The optical transmission system of this embodiment uses optical multiplexers/demultiplexers a14 and b14 used for DWDM or CWDM when performing communication between the 1st adapter and the 2nd adapter, and recognizes an internal reflectance generated in the optical cable C connecting the 1st adapter and the 2nd adapter, and display the internal reflectance on each of the liquid crystal display units a1 and b1. Description of the second invention and the third invention

The optical transmission system of this embodiment is provided with one or two or more types of hour meters z6 on the display part. when communication is performed between the 1st adapter A and the 2nd adapter B. As for the display of the hour meter, since several displays are used depending on the purpose, the number of displays may be controlled from the LCD boards a13 and b13. Description of the fourth invention.

The optical transmission system of this embodiment is provided with a circuit board a3 for supporting connection of the PTP clock when communication between the 1st adapter A and the 2nd adapter B is performed and when the devices D1 and D2 that require PTP clock synchronization are connected by the cables M1 and M9. The counterpart adapter also has a circuit board b3 corresponding to PTP clock synchronization, enabling communication. Description of the Fifth Invention

In the optical transmission system of the present embodiment, when communication is performed between the 1st adapter A and the 2nd adapter B, a TW specification intercom E1 capable of sending two lines to the 1st adapter A is attached with a cable M2, Also, the RW specification intercom E2 corresponding to the 2nd adapter B is attached with M10. Description of the sixth invention

The optical transmission system of this embodiment transmits a video signal to the prompter when communicating between the 1st adapter A and the 2nd adapter B, and the 1st adapter A has a remote control terminal for operating the prompter, and connect remote control F1 for prompter operation to the terminal with cable M3. The 2nd adapter B has a remote control signal output terminal, and by connecting to the prompter F2 with a cable M11, the 1st adapter A can control the prompter F2. Description of the seventh invention

In the optical transmission system of this embodiment, when communication is performed between the 1st adapter A and the 2nd adapter B, the call button G1, the buzzer Ga2, and the LED Ga1 are connected to the inside of the 1st adapter A and the 2nd adapter B by cables M4, M12 and M13. From the 1st adapter A to the 2nd adapter B, or from the 2nd adapter B to the 1st adapter A, the call of the other party is notified by buzzer Ga2 and LED Ga1 in both directions. Description of the eighth invention

In the optical transmission system of this embodiment, when communication is performed between the 1st adapter A and the 2nd adapter B, power is supplied from the 1st adapter A to the 2nd adapter B using an optical cable. Conventionally, power is supplied directly from the 1st adapter A to the 2nd adapter B, which acts as a switch, but before powering the 2nd adapter B, the TW intercom E2 connected to the 2nd adapter B is powered by M14 so that the TW intercom E2 is always powered regardless of the presence or absence of the power supply of the 2nd adapter. Description of the ninth invention.

In the optical transmission system of this embodiment, when communication between the 1st adapter A and the 2nd adapter B is performed, when a contact or voltage tally signal is input to both FAN a4 and b4, a board equipped with a function to turn off power to FAN a4 and b4 is installed. For example, when a tally signal is sent from the 1st adapter A to the 2nd adapter B, the fan b4 will automatically stop. Description of the tenth invention.

In the optical transmission system of this embodiment, when communication is performed between the 1st adapter A and the 2nd adapter B, a board is installed to arbitrarily decide the stop time on the FAN a4 and b4 stop boards of the 1st adapter A and the 2nd adapter B so that when the tally signal comes and FAN a4 and b4 stop, it becomes possible to freely change the fixed stop time. Description of the eleventh invention.

In the optical transmission system of this embodiment, when communication is performed between the 1st adapter A and the 2nd adapter B, the video switcher I1 connected to the 1st adapter A or the 2nd adapter B is connected to the tally by the cable M18. A signal is connected to another 1st adapter BB by M15, and a plurality of units are connected by daisy chaining to another 1st adapter BB. Description of the twelfth invention.

In the optical transmission system of this embodiment, when communication is performed between the 1st adapter A and the 2nd adapter B, the tally signal connected to the video switcher I1 connected to the 1st adapter or the 2nd adapter is transferred to another 1st adapter A, and daisy-chaining to another 1st adapter BB so that plurality of units are connected. At that time, it has a setting function to select a number for which the tally signal lights up, assign the tally signal sent from the video switcher I1 to an arbitrary camera N1, and light it up on the tally display unit I2 or the like. Description of the thirteenth invention.

In the optical transmission system of this embodiment, when communication is performed between the 1st adapter A and the 2nd adapter B, the functions a5 and b5 for generating color bars are provided in the 1st adapter A and the 2nd adapter B, respectively. and outputs a color bar through the output connector A18. Description of the fourteenth invention.

In the optical transmission system of this embodiment, when communication is performed between the 1st adapter A and the 2nd adapter B, each of the 1st adapter A and the 2nd adapter B has functions a6 and b6 for generating color bars with arbitrarily set data amount such as 3G or 12G, and outputs the color bars from output connectors a18 and b18. Description of the fifteenth invention.

In the optical transmission system of this embodiment, when communication is performed between the 1st adapter A and the 2nd adapter B, each of the 1st adapter A and the 2nd adapter B has functions a7 and b7 for generating a 1 KHz audio reference signal, and outputs the 1 KHz audio reference signal through output connectors a19 and b19. Description of the sixteenth invention.

In the optical transmission system of this embodiment, when communication is performed between the 1st adapter A and the 2nd adapter B, each of the 1st adapter A and the 2nd adapter B generates the color bars and the audio reference signals a8 and b8 at the same time, and output from the output connectors a19 and b19 at the same time. Description of the seventeenth invention.

In the optical transmission system of this embodiment, when communication is performed between the 1st adapter A and the 2nd adapter B, a time code signal a9 is connected to the 1st adapter A, the time code signal is output as a through-out a10, and can be connected to any camera N2 or other equipment. Description of the eighteenth invention.

In the optical transmission system of this embodiment, when communication is performed between the 1st adapter A and the 2nd adapter B, time code signals a11 and b11 are generated for the 1st adapter A and the 2nd adapter B, respectively, and the time code signals are output from output connectors a10 and b10. Description of the nineteenth invention.

In the optical transmission system of this embodiment, when communication is performed between the 1st adapter A and the 2nd adapter B, black burst signals a12 and b12 are generated for the 1st adapter A and the 2nd adapter B, respectively, and the black burst signals are output from output connectors a20 and b20. Description of the twentieth invention.

In the optical transmission system of this embodiment, when communication is performed between the 1st adapter A and the 2nd adapter B, the 1st adapter A and another 1st adapter BB are connected with multiple link cables C2. The information content of the 1st adapter is read by a plurality of other 1st adapters using the link cables C2, and displayed on a1 and b1. Description of the 21st invention.

### <Configuration of Contents of Optical Fiber Cable>

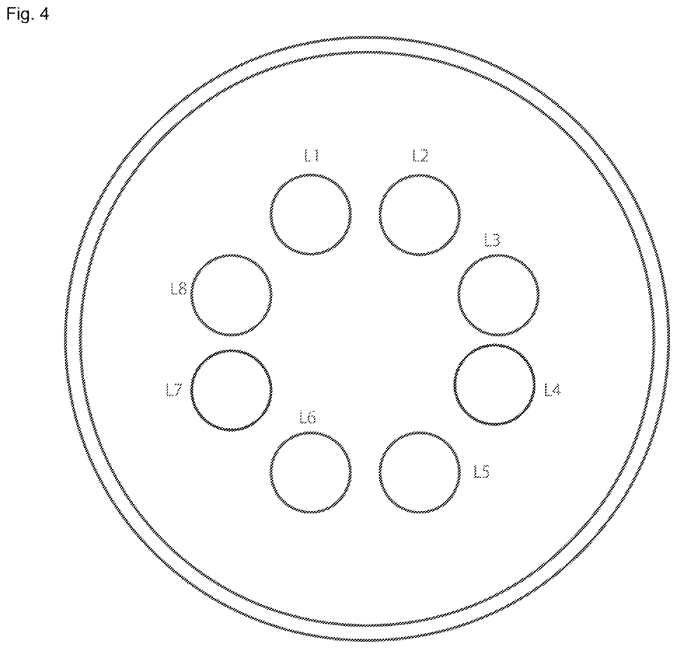

An optical transmission system according to one embodiment of the present invention will be described below with reference to FIG. 4 In the optical transmission system of this embodiment, when communication is performed between the 1st adapter A and the 2nd adapter B, since the two optical cables L1 and L2 are built in the broadcasting SMPTE cable, a21 and b21 that transmit DWDM or CWDM frequency signals to the optical cable are attached inside of only one of the 1st adapter A and the 2nd adapter B, so that when the signal is interrupted, the switch is switched to the other optical cable so that the signal is transmitted via the other optical cable. Description of the 22nd invention.

In the optical transmission system of this embodiment, when communication is performed between the 1st adapter A and the 2nd adapter B, since two optical cables L1 and L2 are built in the broadcast SMPTE cable, the same signals are transmitted to the two optical cables L1 and L2 inside the 1st adapter A and the 2nd adapter B at the same time. Description of the twenty-third invention.

In the optical transmission system of this embodiment, when communication is performed between the 1st adapter A and the 2nd adapter B, the input sources of the power sources of the 1st adapter and the 2nd adapter are automatically identified and displayed on the liquid crystal display portions a1 and b1. The power source of the 2nd adapter B is confirmed from the 1st adapter, and the power source of the 1st adapter A is confirmed on the power display part z2 of the liquid crystal unit of the 2nd adapter. Description of the twenty-fourth invention.

In the optical transmission system of this embodiment, when communication is performed between the 1st adapter A and the 2nd adapter B, wherein the amount of data is down-converted by the down-conversion circuit a15 to the through-out connector a16 of the video output signal of the 1st adapter and the 2nd adapter B, and the video signal is output from the video signal terminal A21. Description of the twenty-fifth invention.

In the optical transmission system of this embodiment, when communication is performed between the 1st adapter A and the 2nd adapter B, when the return signal sent from the 2nd adapter B via the optical cable is output from the 1st adapter A, a switch a17 for selecting the video signal from the 2nd adapter B from the plurality of return signals is attached. The 1st adapter A outputs and uses the selected return video. Description of the 26th invention.

### <Description of Intercom>

In the optical transmission system of this embodiment, when communication is performed between the 1st adapter A and the 2nd adapter B, when the intercoms H1 and H2 communicate between the 1st adapter A and the 2nd adapter B using the cables M5 and M14, indicators z11, z12, z13 and z14 for displaying the audio levels for the respective intercoms H1 and H2. Description of the twenty-seventh invention.

In the optical transmission system of this embodiment, when communication is performed between the 1st adapter A and the 2nd adapter B, when the Clear cam master unit K1 and slave unit K2 are connected to each other's optical transmission system adapters via cables M8 and M17, it has a function of supplying power to the slave unit K2 only when the master unit K1 of the Clear cam is powered on. Description of the 28th invention.

### EXPLANATION OF REFERENCE NUMERALS

A: 1st adapter
a1: 1st adapter display liquid crystal unit
a2: 1st adapter light internal reflectance sensor
a3: 1st adapter PTP clock support circuit
a4: 1st adapter FAN
a5: 1st adapter color bar generator
a6: 1st adapter color bar generator with arbitrary amount of data
a7: 1st adapter 1 kHz audio signal generation circuit
a8: 1st adapter color bar & 1 kHz audio signal simultaneous generation circuit
a9: 1st adapter time code signal circuit
a10: 1st adapter time code signal output terminal
a11: 1st adapter time code generator
a12: 1st adapter black burst signal generator
a13: 1st adapter liquid crystal display board
a14: 1st adapter optical multiplexer/demultiplexer
a15: 1st adapter down conversion circuit
a16: 1st adapter video through-out terminal
a17: 1st adapter video signal selection switch
a18: 1st adapter color bar output terminal
a19: 1st adapter audio reference signal output terminal
a20: 1st adapter black burst signal output terminal
a21: 1st adapter optical fiber selection switch
a22: 1st adapter down-converted video output terminal
B: 2nd adapter
b1: 2nd adapter display liquid crystal unit
b2: 2nd adapter optical internal reflectance sensor
b3: 2nd adapter PTP clock support circuit
b4: 2nd adapter FAN
b5: 2nd adapter color bar generator
b6: 2nd adapter color bar generator with arbitrary amount of data
b7: 2nd adapter 1 kHz audio signal generation circuit
b8: 2nd adapter color bar & 1 kHz audio signal simultaneous generation circuit
b9: 2nd adapter time code signal circuit
b10: 2nd adapter time code signal output terminal
b11: 2nd adapter time code generator
b12: 2nd adapter black burst signal generator
b13: 2nd adapter liquid crystal display board
b14: 2nd adapter optical multiplexer/demultiplexer
b15: 2nd adapter down conversion circuit
b16: 2nd adapter video through-out terminal
b17: 2nd adapter video signal selection switch
b18: 2nd adapter color bar output terminal
b19: 2nd adapter audio reference signal output terminal
b20: 2nd adapter black burst signal output terminal
b21: 2nd adapter optical fiber selection switch
b22: 2nd adapter down-converted video output terminal
BB: Daisy chained adapter for optical transmission system
C: Optical transmission cable
C2: Link cable
D1: PTP clock compatible device
D2: PTP clock compatible device
E1: TW intercom
E2: RW intercom
F1: prompter remote control
F2: prompter
G1 call button
Ga1: LED lamp
Ga2: Buzzer
H1: Intercom
H2: Intercom
I1: Video switcher
I2: Tally display unit
J1: Monitor
J2: Return switching
K1: Clear cam main unit
K2: Clear cam slave unit
L1: optical fiber 1
L2: optical fiber 2
L3: Power line 1
L4: Power line 2
L5: Power line 3
L6: Power line 4
L7: signal line 1
L8: signal line 2
M1: 1st adapter and PTP clock compatible device connection cable
M2: 1st adapter and TW intercom connection cable
M3: 1st adapter and remote control connection cable for prompter
M4: 1st adapter and call button connection cable
M5: 1st adapter and intercom connection cable
M6: 1st adapter and video switcher connection cable
M7: 1st adapter and monitor connection cable
M8: 1st adapter and clear cam base unit connection cable
M9: 2nd adapter and PTP clock compatible device connection cable
M10: 2nd adapter and TW intercom connection cable
M11: 2nd adapter and prompter connection cable
M12: 2nd adapter and LED lamp connection cable
M13: 2nd adapter and buzzer connection cable
M14: 2nd adapter and intercom connection cable
M15: Camera and tally display unit connection cable
M16: 2nd adapter and return switching video connection cable
M17: 2nd adapter and clear cam cordless handset connection cable
M18: 2nd adapter and camera connection cable 1
M19: 2nd adapter and camera connection cable 2
N1: Camera connected to adapter for optical transmission system
N2: Camera connected to adapter for optical transmission system
z1: SDI display part of optical transmission system adapter display liquid crystal unit
z2: selected power supply display part of optical transmission system adapter display liquid crystal unit
z3: ALLY display part of optical transmission system adapter display liquid crystal unit
z4: light intensity display part 1 of optical transmission system adapter display liquid crystal unit
z5: light intensity display part 2 of optical transmission system adapter display liquid crystal unit
z6: Hour meter display part of optical transmission system adapter display liquid crystal unit
z7: time code display part of optical transmission system adapter display liquid crystal unit
z8: intercom display part of optical transmission system adapter display liquid crystal unit
z9: remote display part of optical transmission system adapter display liquid crystal unit
z10: nameplate display part of optical transmission system adapter display liquid crystal unit
z11: analog audio input side meter display part of optical transmission system adapter display liquid crystal unit
z12: analog audio output side meter display part of optical transmission system adapter display liquid crystal unit
z13: digital audio input side meter display part of optical transmission system adapter display liquid crystal unit
z14: digital audio output side meter display part of optical transmission system adapter display liquid crystal unit

What is claimed:

1. An adapter for an optical transmission system for optically transmitting analog video signals, digital video signals, control signals, audio signals, or a combination thereof between a pair of the adapters, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, at least one of an internal reflectance of the optical cable and light intensity in multiple frequency bands can be displayed on a display part.

2. The adapter of claim 1, wherein the internal reflectance of the optical cable can be displayed on the display part.

3. The adapter of claim 1, wherein light intensity in multiple frequency bands can be displayed on the display part.

4. The adapter of claim 1, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, two types or multiple hour meters can be displayed on the display part.

5. The adapter of claim 1, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, a device that requires synchronization of the PTP clock can be connected, and the other side of the optical transmission device to which the synchronization signal is transmitted has a circuit compatible with the PTP clock.

6. The adapter of claim 1, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, it is possible to connect a TW specification intercom capable of sending two intercom lines to a 1st adapter of the pair of the adapters, and directly connect a RW specification intercom to a 2nd adapter of the pair of the adapters.

7. The adapter of claim 1, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, a video signal for a prompter is transmitted, a 1st adapter of the pair of the adapters has a prompter-dedicated remote control terminal to which a prompter remote control can be connected, a prompter externally connected to a 2nd adapter of the pair of the adapters can be controlled via the 1st adapter.

8. The adapter of claim 1, wherein from a 1st adapter of the pair of the adapters to a 2nd adapter of the pair of the adapters or vice versa, by pressing the call button from one adapter side, the LED lamp on the other side lights up or flashes for display, or a buzzer sounds, so that the other party can be notified with either or both of the buzzer and LED lamp.

9. The adapter of claim 1, wherein when the power is connected to a 1st adapter of the pair of the adapters and a 2nd adapter of the pair of the adapters is connected to the 1st adapter with a cable, the intercom line intercept the power from the 1st adapter before the power switch of the second adapter even without turning on the power switch of the second adapter, and the intercom line has a circuit that keeps the power of the intercom line always on when the 1st adapter is connected, so that communication and a call is always possible.

10. The adapter of claim 1, wherein when the tally signal connected to the adapter is input, the fan inside the adapter is stopped.

11. The adapter of claim 1, wherein when the tally signal connected to the adapter is input, the fan inside the optical is stopped, and the stop time of the FAN can be changed.

12. The adapter of claim 1, wherein a time code signal can be connected to a 1st adapter of the pair of the adapters and the 1st adapter has a through-out output terminal for the time code signal.

13. The adapter of claim 1, wherein either or both of the pair of the adapters have a built-in time code generator and output a time code signal.

14. The adapter of claim 1, wherein either or both of the pair of the adapters have a built-in black burst signal generator and output a black burst signal.

15. The adapter of claim 1, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, since a broadcast SMPTE cable contains two optical cables, the signal from the optical multiplexer/demultiplexer can be divided into two and the same optical signal can be sent to the two optical cables of one SMPTE cable at the same time.

16. The adapter of claim 1, wherein when the pair of the adapters are used with optical multiplexer/demultiplexers provided on both of the adapters, the optical multiplexer/demultiplexers being used to transmit the signals with multiple frequencies such as CWDM or DWDM through a single optical cable, since a broadcasting SMPTE cables contain two optical cables, the signal from the optical multiplexer/demultiplexer is optically transmitted through one of the optical cables, and when the signal is interrupted, the optical switch switches one of the optical cable to the other of the optical cable, and the signal from the optical multiplexer/demultiplexer can be sent via the other of the optical cable.

17. The adapter of claim 1, wherein the adapter has a function that can output via the through-out terminal an image obtained by down-converting the data amount of the input digital video signal.

18. The adapter of claim 1, wherein when a signal to switch the return signal to the monitor is sent to either or both of the pair of the adapters, from a remote controller, etc., the return signal input to the other adapter can be selected.

19. The adapter of claim 1, wherein the adapter has a function to visualize the volume level of the intercom with an indicator.

20. The adapter of claim 1, wherein when the Clear-com master and slave devices are connected to each other's adapters, power is supplied to the slave device only when the Clear-com master device is powered on.
